(19) United States
(12) Patent Application Publication
(10) Pub. No.: US 2025/0022372 A1
(43) Pub. Date: Jan. 16, 2025

(54) BUILDING MANAGEMENT SYSTEM WITH INTEGRATED ENTITY MANAGEMENT

(71) Applicant: Tyco Fire & Security GmbH, Neuhausen am Rheinfall (CH)

(72) Inventors: Alan John Perrott, Leighton Buzzard (GB); Neha Mahesh Deshpande, Pune (IN); Abhigyan Chatterjee, Dubai (AE)

(21) Appl. No.: 18/773,223

(22) Filed: Jul. 15, 2024

(30) Foreign Application Priority Data
Jul. 13, 2023 (IN) 202321047340

(51) Int. Cl. G08G 1/14; G06Q 10/1093

(52) U.S. Cl. CPC G08G 1/149; G06Q 10/1095; G08G 1/148

(57) ABSTRACT

A system can include one or more memory devices. The one or more memory devices can store instructions thereon. The instructions can, when executed by one or more processors, cause the one or more processors to receive a request for a meeting at the building, identify an external attendee for the meeting, retrieve one or more datasets that represent one or more parking spots of the plurality of parking spots that correspond to the meeting parameters, transmit one or more signals to the parking system to reserve a given parking spot of the one or more parking spots for the external attendee, generate an invite to the meeting for the external attendee, detect a modification to the request for the meeting, and automatically modify the reservation of the given parking spot for the external attendee by adjusting one or more parameters of the reservation of the given parking spot.

### CROSS-REFERENCE TO RELATED PATENT APPLICATIONS

This application claims the benefit of and priority to Indian Provisional Patent Application No. 202321047340, filed Jul. 13, 2023, the entirety of which is incorporated by reference herein.

### BACKGROUND

The present disclosure relates generally to visitor management. More particularly, the present disclosure relates to visitor management methods and systems integrated with meeting scheduling and parking reservation.

### SUMMARY

One implementation of the present disclosure relates to a visitor management method executed by one or more processors. The visitor management method includes identifying at least one external attendee in a meeting request for a meeting and synchronizing at least one of parking reservation and premise entry invite with one or more meeting parameters for the external attendee. The method further includes transmitting a first notification to the external attendee regarding at least one of the parking reservation and the premise entry invite.

In some embodiments, the steps further include receiving a modification in at least one meeting parameter of the meeting request, and updating at least one of the parking reservation and the premise entry invite based on the modification. In some embodiments, the steps further include transmitting a second notification regarding at least one of the updated parking reservation and the updated premise entry invite to the external attendee. In some embodiments, the modification in the meeting parameter includes a cancelation of the meeting request. In some embodiments, the update of the parking reservation and the premise entry invite include cancelation of the parking reservation and the premise entry invite, respectively. In some embodiments, the steps further include determining a number of meetings to be attended by the external attendee in a day. The synchronization of the at least one of parking reservation and premise entry invite is further based on an aggregate schedule of the meetings. In some embodiments, the one or more meeting parameters include at least one of a meeting time, a meeting place, a number of parking slots to be reserved, and available attendees. In some embodiments, a parking reservation time period is based on a meeting duration identified in the meeting request and a buffer time. In some embodiments, the steps further include generating a recommendation for a meeting host to reschedule the meeting in response to unavailability of parking for the external attendee. In some embodiments, the steps further include generating an alert, before a predetermined time period from a meeting end time, to notify the external attendee regarding expiration of the parking reservation. In some embodiments, the steps further include extending the parking reservation upon receiving a confirmation from the external attendee or a meeting host based on parking availability.

Another implementation of the present disclosure relates to an integrated visitor management system. The integrated visitor management system includes one or more memories configured to store a list of premise occupants and one or more processors. The one or more processors are configured to identify at least one external attendee in a meeting request for a meeting based on the stored list of premise occupants and synchronize at least one of parking reservation and premise entry invite with one or more meeting parameters for the external attendee. The one or more processors are further configured to transmit a notification to the external attendee regarding at least one of the parking reservation and the premise entry invite.

At least one embodiment relates to a system. The system can include one or more memory devices. The one or more memory devices can store instructions thereon. The instructions can, when executed by one or more processors, cause the one or more processors to receive, via an application integrated within a meeting system of a building, a request for a meeting at the building. The request can include (1) information to identify an external attendee for the meeting at the building and (2) meeting parameters. The instructions can cause the one or more processors to identify, based at least on the information included in the request, the external attendee. The instructions can cause the one or more processors to retrieve, from a parking system that controls access to a plurality of parking spots for the building, one or more datasets that represent one or more parking spots of the plurality of parking spots that correspond to the meeting parameters. The instructions can cause the one or more processors to transmit one or more signals to the parking system to reserve a given parking spot of the one or more parking spots for the external attendee. The instructions can cause the one or more processors to generate an invite to the meeting for the external attendee. The invite can include an access control credential for the external attendee to provide access to the given parking spot. The instructions can cause the one or more processors to detect a modification to the request for the meeting. The instructions can cause the one or more processors to automatically modify the reservation of the given parking spot for the external attendee by adjusting one or more parameters of the reservation of the given parking spot to reflect the modification to the request for the meeting.

In some embodiments, the modification to the request for the meeting can include at least one of a cancellation of the request for the meeting, a change to a time of the meeting, a change to a location of the meeting, or a change to a date of the meeting.

In some embodiments, adjusting the one or more parameters of the reservation of the given parking spot can include retrieving, from the parking systems, one or more second datasets that represent one or more second parking spots of the plurality of parking spots, and transmitting one or more second signals to the parking system to reserve a second given parking spot of the one or more second parking spots.

In some embodiments, adjusting the one or more parameters of the reservation of the given parking spot can include transmitting one or more second signals to the parking system to change the reservation of the parking spot to reflect the change to the date of the meeting, and transmitting one or more third signals to a computing device of the external attendee to indicate the change to the reservation of the parking spot.

In some embodiments, the application integrated within the meeting system can include at least one of an application stored on a user device that created the request, a calendar software configured to receive one or more requests for meetings, or a computing device located within the building.

In some embodiments, the request for the meeting can be provided to the application by a computing device associated with a host of the meeting. The instructions can cause the one or more processors to retrieve, from a database, a set of permissions associated with the host, the set of permissions to identify one or more second parking spots of the plurality of parking spots that the host has permission to reserve. The one or more second parking spots can include the one or more parking spots.

In some embodiments, adjusting the one or more parameters of the reservation of the given parking spot can include automatically updating one or more parameters of the access control credential to reflect the modification to the request for the meeting. Updating the one or more parameters of the access control credential can include at least one of adjusting a start time for which the access control credential provides access to the given parking spot, or adjusting an end time for which the access control credential no longer provides access to the given parking spot.

In some embodiments, the request for the meeting can include includes an indication of a plurality of external attendees for the meeting. The plurality of external attendees can include the external attendee. The instructions can cause the one or more processors to monitor, responsive to generation of the invite, one or more interactions with the application integrated within a meeting system. The instructions can cause the one or more processors to detect, responsive to monitoring the one or more interactions, the modification to the request for the meeting. The instructions can cause the one or more processors to determine, responsive to detection of the modification to the request for the meeting, a number of external attendees of the plurality of external attendees that have parking reservations at the building. The instructions can cause the one or more processors to transmit, responsive to determination of the number of external attendees, one or more second signals the parking system to modify the parking reservations to reflect the modification to the request for the meeting.

At least one embodiment relates to a method. The method can include receiving, by one or more processing circuits, via an application integrated within a meeting system of a building, a request for a meeting at the building. The request can include (1) information to identify an external attendee for the meeting at the building and (2) meeting parameters. The method can include identifying, by the one or more processing circuits, based at least on the information included in the request, the external attendee. The method can include retrieving, by the one or more processing circuits, from a parking system that controls access to a plurality of parking spots for the building, one or more datasets that represent one or more parking spots of the plurality of parking spots that correspond to the meeting parameters. The method can include transmitting, by the one or more processing circuits, one or more signals to the parking system to reserve a given parking spot of the one or more parking spots for the external attendee. The method can include generating, by the one or more processing circuits, an invite to the meeting for the external attendee. The invite can include an access control credential for the external attendee to provide access to the given parking spot. The method can include detecting, by the one or more processing circuits, a modification to the request for the meeting. The method can include automatically modifying, by the one or more processing circuits, the reservation of the given parking spot for the external attendee by adjusting one or more parameters of the reservation of the given parking spot to reflect the modification to the request for the meeting.

In some embodiments, the modification to the request for the meeting can include at least one of a cancellation of the request for the meeting, a change to a time of the meeting, a change to a location of the meeting, or a change to a date of the meeting.

In some embodiments, adjusting the one or more parameters of the reservation of the given parking spot can include retrieving, by the one or more processing circuits, from the parking systems, one or more second datasets that represent one or more second parking spots of the plurality of parking spots, and transmitting, by the one or more processing circuits, one or more second signals to the parking system to reserve a second given parking spot of the one or more second parking spots.

In some embodiments, adjusting the one or more parameters of the reservation of the given parking spot can include transmitting, by the one or more processing circuits, one or more second signals to the parking system to change the reservation of the parking spot to reflect the change to the date of the meeting, and transmitting, by the one or more processing circuits, one or more third signals to a computing device of the external attendee to indicate the change to the reservation of the parking spot.

In some embodiments, the application integrated within the meeting system can include at least one of an application stored on a user device that created the request, a calendar software configured to receive one or more requests for meetings, or a computing device located within the building.

In some embodiments, the request for the meeting can be provided to the application by a computing device associated with a host of the meeting. The method can include retrieving, by the one or more processing circuits, from a database, a set of permissions associated with the host, the set of permissions to identify one or more second parking spots of the plurality of parking spots that the host has permission to reserve. The one or more second parking spots can include the one or more parking spots.

In some embodiments, adjusting the one or more parameters of the reservation of the given parking spot can include automatically updating, by the one or more processing circuits, one or more parameters of the access control credential to reflect the modification to the request for the meeting. Updating the one or more parameters of the access control credential can include at least one of adjusting, by the one or more processing circuits, a start time for which the access control credential provides access to the given parking spot, or adjusting, by the one or more processing circuits, an end time for which the access control credential no longer provides access to the given parking spot.

In some embodiments, the request for the meeting can include an indication of a plurality of external attendees for the meeting. The plurality of external attendees can include the external attendee. The method can include monitoring, by the one or more processing circuits, responsive to generation of the invite, one or more interactions with the application integrated within a meeting system. The method can include detecting, by the one or more processing circuits, responsive to monitoring the one or more interactions, the modification to the request for the meeting. The method can include determining, by the one or more processing circuits, responsive to detection of the modification to the request for the meeting, a number of external attendees of the plurality of external attendees that have parking reservations at the building. The method can include transmitting, by the one or more processing circuits, responsive to determination of the number of external attendees, one or more second signals the parking system to modify the parking reservations to reflect the modification to the request for the meeting.

At least one embodiment relates to one or more non-transitory storage media. The one or more non-transitory storage media can store instructions thereon. The instructions can, when executed by one or more processors, cause the one or more processors to operations that include receiving, via an application integrated within a meeting system of a building, a request for a meeting at the building. The request can include (1) information to identify an external attendee for the meeting at the building and (2) meeting parameters. The operations can include identifying, based at least on the information included in the request, the external attendee. The operations can include retrieving, from a parking system that controls access to a plurality of parking spots for the building, one or more datasets that represent one or more parking spots of the plurality of parking spots that correspond to the meeting parameters. The operations can include transmitting one or more signals to the parking system to reserve a given parking spot of the one or more parking spots for the external attendee. The operations can include generating an invite to the meeting for the external attendee. The invite can include an access control credential for the external attendee to provide access to the given parking spot. The operations can include detecting a modification to the request for the meeting. The operations can include automatically modifying the reservation of the given parking spot for the external attendee by adjusting one or more parameters of the reservation of the given parking spot to reflect the modification to the request for the meeting.

In some embodiments, the modification to the request for the meeting can include at least one of a cancellation of the request for the meeting, a change to a time of the meeting, a change to a location of the meeting, or a change to a date of the meeting.

In some embodiments, adjusting the one or more parameters of the reservation of the given parking spot can include retrieving, from the parking systems, one or more second datasets that represent one or more second parking spots of the plurality of parking spots, and transmitting one or more second signals to the parking system to reserve a second given parking spot of the one or more second parking spots.

In some embodiments, adjusting the one or more parameters of the reservation of the given parking spot can include transmitting one or more second signals to the parking system to change the reservation of the parking spot to reflect the change to the date of the meeting, and transmitting one or more third signals to a computing device of the external attendee to indicate the change to the reservation of the parking spot.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram that illustrates a smart building environment implementing an integrated visitor management system, according to some embodiments.

FIG. 2 is a flow chart of a method to automatically manage visits of external attendees, according to some embodiments.

FIG. 3 is a flow chart of a method to automatically synchronize an external attendee visit with updated meeting parameters, according to some embodiments.

FIG. 4 is a flow chart of a method to automatically synchronize an external attendee visit with updated meeting parameters, according to some embodiments.

FIG. 5 is a flow chart of a method to automatically synchronize an external attendee visit with updated meeting parameters, according to some embodiments.

FIG. 6 is a flow chart of a method to automatically cancel an external attendee visit when meeting is canceled or when the external attendee is removed from the meeting, according to some embodiments.

FIG. 7 is a block diagram of system to provide meeting integration for a Building Management System, according to some embodiments.

FIG. 8 is a flow diagram of a method to provide meeting integration for a Building Management System, according to some embodiments.

### DETAILED DESCRIPTION

### Overview

An important user experience in a smart building or smart campus is that of a visitor, whether that be an internal executive, a customer or partner, an interview candidate, or any other guest. In any case, the visitor's first impression of an organization they are visiting is often the visitor management experience. Process for managing visits consists of several different unconnected tasks such as creating a meeting, identifying which meeting attendees are external visitors, inviting the external visitors, and reserving parking for the external visitors. If the meeting is subsequently changed or canceled, the corresponding visit and parking reservations are required to be updated.

Visitor management systems may be implemented in buildings to handle various tasks associated with visitors such as customers, vendors, interview candidates, or any other guests. In current visitor management systems, tasks such as sending premise entry invites, reserving parking slots for the external attendees, and notifying the external attendees are performed manually. These tasks are frequently missed, incomplete, or are not synchronized with the visitor's schedule. For example, a visitor may arrive at the wrong time for the meeting, may arrive to find that the meeting has been canceled or moved to another location, or may find that parking either has not been reserved or has been reserved for the wrong time. These difficulties may result in an overall negative visitor experience.

Some technical solutions of the present disclosure include systems and methods to provide an integrated approach for visitor management. The integrated approach for visitor management may include a visitor management system integrated with various systems to provide an end-to-end automated solution for visitor management. For example, when a user (e.g., a meeting host) creates a meeting with one or more attendees, the visitor management system automatically identifies external attendees invited to the meeting. The visitor management system may also automatically prompt the meeting host to invite the external attendees to visit the premises for the meeting. As another example, the visitor management system prompts the meeting host to indicate if the external attendees will park on the premises. The visitor management system may automatically reserve parking for the time of the meeting based on a number of external attendees parking on the premises. As another example, the visitor management system may automatically update any parking reservation or visit request based on changes to the meeting (e.g., time, date, location, etc.). The visitor management system may automatically cancel the visit invitations and parking reservation based on a cancellation of the meeting. Furthermore, the visitor management system allows for an individual visitor to attend multiple meetings on the same day. In such a scenario, the visitor management system automatically aggregates the meetings, managing a single visit invitation and parking reservation that can accommodate each of the meetings.

In some embodiments, an external attendee may refer to and/or include at least one of one or more individuals that are not affiliated with an owner or a tenant of a building and/or one or more spaces thereof, employees or other affiliated individuals/contractors who do not have access to a particular building and/or one or more spaces thereof (e.g., visitors from another office), and/or individuals who are affiliated with a building and/or one or more spaces thereof but do not have regular access to the building (e.g., room sharing, room hoteling, office hoteling, etc.). While some examples of external attendees have be provided herein, these examples are for illustrative purposes only and are in no way limiting in scope.

Before turning to the Figures, it should be understood that the disclosure is not limited to the details or methodology set forth in the description or illustrated in the figures. It should also be understood that the terminology is for the purpose of description only and should not be regarded as limiting. Referring generally to the Figures, visitor management methods and systems integrated with meeting scheduling and parking reservation are shown and described.

### Visitor Management System

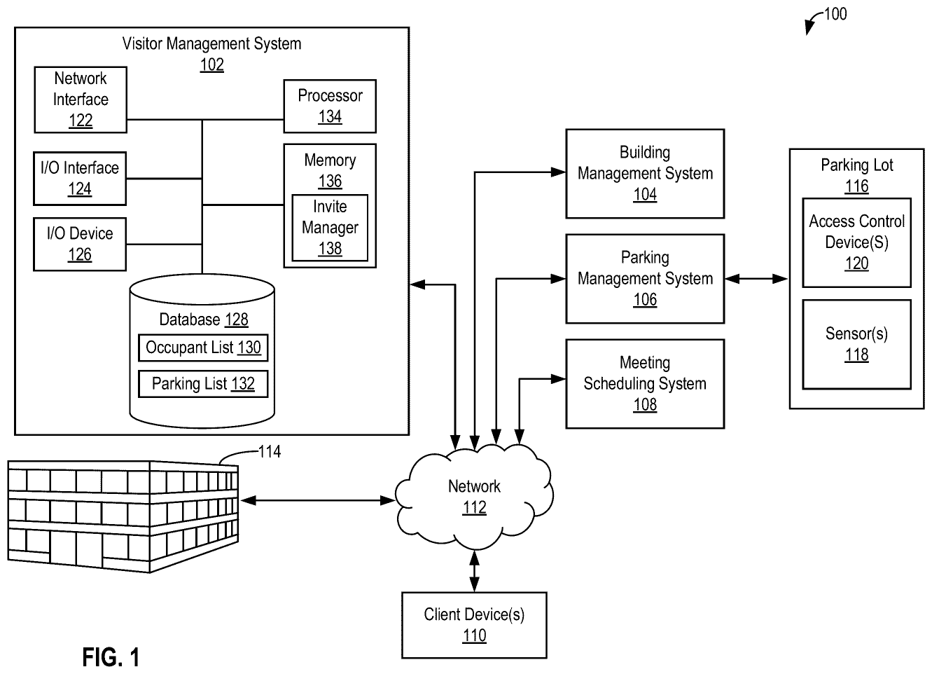

FIG. 1 depicts a block diagram of a system 100, according to some embodiments. The system 100 and/or one or more components thereof may refer to and/or include a smart building environment. In some embodiments, the system 100 may include a visitor management system 102, one or more building systems (shown as a building management system (BMS) 104, a parking management system 106, and a meeting scheduling system 108 in FIG. 1), a plurality of client devices 110, a network 112, a building 114, and a parking lot 116. In some embodiments, the various systems, devices, and/or components of the system 100 may include one or more processors coupled with memory. The one or more processors may execute instructions, stored in memory, that cause the one or more processors to perform one or more of the various processes, methods, or actions described herein. In some embodiments, the various systems, devices, and/or components of the system 100 may be communicably coupled with one another via the network 113. The system 100 and/or one or more systems, devices, and/or components may be modified, adjusted, altered, or otherwise changed. For example, a first device that is shown to include two separate components may be modified such that the two separate components are combined into a single component. As another example, the system 100 may be changed such that one or more actions performed by a first device may be performed by a second device. In some embodiments, one or more systems, devices, and/or components of the system 100 may be replaced, removed, added, or otherwise substituted.

In some embodiments, the network 112 may refer to and/or include at least one of a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. In some embodiments, the network 112 may include hardware and/or devices to facilitate communication between devices. For example, the network 112 may include an antenna. As another example, the network 112 may include a network adapter or network card.

In some embodiments, the BMS 104 may be associated with one building (e.g., the building 114). In other embodiments, the BMS 104 may be associated with multiple buildings. The BMS 104 may facilitate management and control of the building 114 and/or various operations described herein. For example, the BMS 104 may control, monitor, and/or manage equipment in or around the building 114 or building area. In some embodiments, the BMS 104 may include a heating, ventilation, air conditioning, and/or refrigeration (HVAC&R) system, a security system, a lighting system, a fire alerting system, an access control system, and any other system that is capable of managing building functions or devices, or any combination thereof. Each system of the BMS 104 may include sensors and other devices (e.g., IoT devices) for operation, maintenance, monitoring, and control of each respective system. In some embodiments, the BMS 104 may communicate with various building subsystems of the building 114. For example, the BMS 104 may communicate with at least one of a fire safety subsystem, a lift/escalators subsystem, a building electrical subsystem, an information communication technology (ICT) subsystem, a security subsystem, an HVAC subsystem, a lighting subsystem, and/or an access control subsystem of the building 114.

In some embodiments, each of building subsystems may include any number of devices (e.g., loT devices), sensors, controllers, and connections to facilitate functions and control activities. For example, the HVAC subsystem may include a chiller, a boiler, any number of air handling units, economizers, field controllers, supervisory controllers, actuators, temperature sensors, and other devices for controlling the temperature, humidity, airflow, or other variable conditions within buildings. As another example, the lighting subsystem may include any number of light fixtures, ballasts, lighting sensors, dimmers, or other devices configured to controllably adjust the amount of light provided to a building space. As another example, the security subsystem may include occupancy sensors, video surveillance cameras, digital video recorders, video processing servers, intrusion detection devices, access control devices and servers, or other security-related devices.

The BMS 104 may further implement one or more building management application(s) to monitor and/or control specific processes/events within the building 114. For example, the building management application(s) may include automated measurement and validation (AM&V), demand response (DR), fault detection and diagnostics (FDD), integrated control systems, and/or a building subsystem integration system. In some embodiments, the building management application(s) may be configured to receive inputs from building subsystems and/or other data sources, determine improved and/or optimal control actions for the building subsystems based on the inputs, generate control signals based on the improved and/or optimal control actions, and provide the generated control signals to the building subsystems. In some embodiments, the BMS 104 may be implemented within a single computer (e.g., one server, one housing, etc.). In various other embodiments, the BMS 104 may be distributed across multiple servers or computers (e.g., that can exist in distributed locations). In some embodiments, functions of the BMS 104 may be implemented as agents. For example, the BMS 104 may include a fault detection agent configured to analyze building data and detect faults associated with building components.

In some embodiments, the parking management system 106 may manage various processes associated with scheduling, assigning, and implementing parking in the parking lot 116. In some embodiments, the parking management system 106 may be implemented within a single computer (e.g., one server, one housing, etc.). In various other embodiments, the parking management system 106 may be distributed across multiple servers or computers (e.g., that can exist in distributed locations). In some embodiments, functions of the parking management system 106 may be implemented as agents. For example, the parking management system 106 may include an occupancy management agent configured to detect which all parking spots are occupied in the parking lot 116.

In some embodiments, the parking management system 106 may identify an individual associated with a vehicle entering the parking lot 116. The parking management system 106 may direct the individual to a parking spot assigned to or reserved for the individual. For example, the parking management system 106 may access a list that includes license plate numbers for each scheduled visitor. The parking management system 106 may identify a given individual responsive to a camera capturing an image of a license plate number associated with the given individual or in any other fashion (e.g., receiving a correlating identifier associated with the individual from a mobile device of the individual, a vehicle of the individual, an access credential device such as a keycard, facial recognition or other biometric input, etc.). In some embodiments, the parking management system 106 may direct the entity by providing directions to an assigned parking spot.

In some embodiments, the parking management system 106 may detect when an individual has arrived at the reserved parking spot. The parking management system 106 may be notify the visitor management system 102 regarding the arrival of the individual when the individual is a visitor. In some embodiments, the parking management system 106 may communicate with the client devices 110 and/or the parking lot 116 via the network 112. The parking management system 106 may implement and/or facilitate various functions associated with managing of the parking lot 116. For example, the parking management system 106 may implement emissions monitoring in the parking lot 116, reservations scheduling (e.g., managing and reserving parking spots within the parking lot 116), digital signage control (e.g., controlling digital signage located in the parking lot 116), lighting control (e.g., controlling lighting within the parking lot 116), transportation management, arrival management (e.g., generating notification in response to detecting an employee arrive at work, directing visitors), payment management (e.g., receiving and processing payment for use of the parking lot 116), and parking monitoring (e.g., monitoring vehicles/individuals using the parking lot 116).

In some embodiments, the parking management system 106 may facilitate renewals of parking spots. For example, a user (e.g., a building occupant) may select a payment instrument to have parking expense (e.g., monthly rent, etc.) automatically deducted from the payment instrument. Additionally, or alternatively, the parking management system 106 may include one or more kiosks to facilitate processing payments. In some embodiments, the parking management system 106 may include digital signage to display information to users (e.g., directions, instructions, etc.).

In some embodiments, the parking management system 106 may facilitate license plate recognition. For example, the parking management system 106 may grant a vehicle access to the parking lot 116 based on identifying a license plate of the vehicle and/or may identify an assigned/reserved parking spot for the vehicle based on identifying the license plate. In some embodiments, the parking management system 106 may facilitate badge scanning. For example, an employee (e.g., a building occupant) may scan an identifier badge to gain access to the parking management system 106. Additionally, or alternatively, the parking management system 106 may detect an employee and/or an individual via near-field-communication (NFC). For example, the parking management system 106 may detect an NFC device mounted to an individual's vehicle and grant the individual access to the parking lot 116.

In some embodiments, the parking management system 106 may facilitate occupancy sensing. For example, the parking management system 106 may determine if a user has arrived at their reserved or assigned parking spot via sensors 118 and notify the visitor management system 102 when the user is a visitor. In some embodiments, the parking management system 106 may monitor air flow and/or CO2. For example, the parking management system 106 may generate an alert if the parking lot 116 lacks fresh air (e.g., emissions levels are too high, etc.). In some embodiments, the parking management system 106 may facilitate notifications. For example, the parking management system 106 may determine using sensor data generated by the sensors 118 that a visitor's vehicle is still parked at their reserved parking spot when their parking reservation is about to expire and notify the visitor management system 102. Such notifications may enable the visitor management system 102 to generate overstay warnings for the visitors.

The parking lot 116 may be any parking lot that includes devices and/or interfaces to communicate with the parking management system 106. The parking lot 116 may include the sensors 118, one or more access control devices 120, and/or one or more user interface devices (not shown). The sensors 118 may include occupancy sensors, cameras, biometric sensors, light sensors, weight sensors, temperature sensors, microphones, and/or any other type of sensor. In some embodiments, the sensors 118 may be configured to collect information about a vehicle and/or individual in or around the parking lot 116 and transmit the information to the parking management system 106. For example, the sensors 118 may capture an image of a vehicle entering the parking lot 116, determine a make and model of the vehicle, and transmit the make and model information to the parking management system 106.

In some embodiments, the visitor management system 102 may generate an access control credential to provide access to the building 114 and/or the parking lot 116. For example, the visitor management system 102 may generate an access control credential for an external attendee of a meeting. In some embodiments, the access control credential may provide access to the building 114. For example, the parking lot 116 may be accessible via the access control credential. As another example, the access control credential may be scanned and/or otherwise provided to an access control device located proximate to an entrance of the building 114 to provide access to the building 114. In some embodiments, the access control credential may include at least one of a Quick-Response (QR) code, a Near Field Communication (NFC) tag, a Radio Frequency Identification (RFID) device, and/or among other possible access code. The access control credential may also be integrated with or linked to a computing device (e.g., the client device 110) such that detection of the client device 110, proximate to the building 114, provides access to the building 114. In some embodiments, the visitor management system 102 may store or otherwise maintain the access control credential to provide access to the building 114. For example, the visitor management system 102 may store credentials and/or permissions for a given external attendee such that the given external attendee may be provided access to the building 114.

In some embodiments, the sensors 118 may include emissions sensors. For example, the sensors 118 may detect CO2 levels within the parking lot 116 and the parking management system 106 may control the BMS 104 to increase fresh airflow to the parking lot 116. The access control devices 120 may include gates, turnstiles, ramps, doors, barriers, and/or any other devices or structures to control access to the parking lot 116. The user interface devices may include displays, voice assistants, gesture detectors, tablets, control panels, remotes, and/or any other user interface device/systems. In some embodiments, a user may interact with the parking lot 116 and/or the parking management system 106 via the user interface devices. For example, a user may check-in at an access gate of the parking lot 116 using a user interface device. In some implementations, the user interface devices may not be a part of the parking management system 106, but may be client devices 110, such as smartphones from which the parking management system 106 receives input data.

In some embodiments, the parking management system 106 may communicate with the visitor management system 102 via the network 112. In some embodiments, the parking management system 106 may maintain a database to store information associated with the parking lot 116. For example, the parking management system 106 may store a list of unused parking spots and reservation schedules of the reserved parking spots. The database may be internal storage with relation to the parking management system 106, and/or may include a remote database, cloud-based data hosting, or other remote data storage, for example, maintained at the visitor management system 102.

In some embodiments, the parking management system 106 may receive data (e.g., biometric information, images, NFC data, and/or the like) from the sensors 118 and identify vehicles and/or individuals. For example, the parking management system 106 may receive an image of a vehicle license plate and identify a license plate number from the image and an individual associated with the license plate number. The parking management system 106 may implement one or more image recognition techniques to determine a license plate number based on an image and search a database using the license plate number to determine an individual having a vehicle with the license plate number. In some embodiments, the access control devices 120 of the parking lot 116 may only allow access when the individual is successfully recognized by the parking management system 106. In some embodiments, the parking management system 106 may control user interface devices in the parking lot 116 to display turn-by-turn directions to an individual driving a vehicle to guide the individual to a reserved parking spot and/or to guide the individual to exit the parking lot 116. As a further example, the parking management system 106 may control lights in the parking lot 116 to illuminate a parking spot reserved for an identified individual.

In some embodiments, the meeting scheduling system 108 may manage various processes associated with scheduling, updating, and canceling meeting requests. In some embodiments, the meeting scheduling system 108 may be implemented within a single computer (e.g., one server, one housing, etc.). In various other embodiments, the meeting scheduling system 108 may be distributed across multiple servers or computers (e.g., that can exist in distributed locations). In some embodiments, functions of the meeting scheduling system 108 may be implemented as agents. For example, the meeting scheduling system 108 may include a meeting scheduling agent configured to schedule a meeting as per meeting parameters defined by a meeting host.

In some embodiments, the meeting scheduling system 108 may schedule a meeting based on a meeting request raised by a meeting host. The meeting scheduling system 108 implement a meeting scheduling service or application using which the meeting host may raise the meeting request. For example, the meeting scheduling service or application may be accessed by the meeting host using a client device (e.g., the client device 110). Further, the meeting host may provide one or more user inputs to specify meeting parameters for the meeting request.

In some embodiments, the meeting parameters may include identifiers (e.g., email addresses) of meeting attendees (e.g., building occupants and/or external attendees/visitors), a preferred meeting time for the meeting, and resources requested for the meeting. The resources requested for the meeting may include a meeting room to host the meeting and/or a number of parking spots to be reserved for the external attendees. The meeting parameters may further include identifiers of those external attendees for whom parking spots are to be reserved. Based on the specified meeting parameters, the meeting scheduling system 108 may recommend one or more available meeting rooms that have a capacity to accommodate the requested attendees. The meeting host or the meeting scheduling system 108 may select one of the meeting rooms for hosting the meeting.

In some embodiments, the meeting scheduling system 108 may receive a confirmation from the visitor management system 102 on whether the requested number of parking spots are available for proposed meeting duration of the meeting. In a scenario where the requested number of parking spots are available, the meeting scheduling system 108 may request the meeting host to confirm the meeting request for scheduling the meeting. However, in a scenario where the requested number of parking spots are unavailable and/or no meeting room is available, the visitor management system 102 may cause the meeting scheduling system 108 to generate a recommendation for the meeting host to modify the meeting parameters (e.g., reschedule the meeting in response to unavailability of parking for the external attendee).

In some embodiments, upon receiving a confirmation from the meeting host, the meeting scheduling system 108 may send a meeting invite (or request) to all those meeting attendees who are occupants of the building 114 (e.g., internal attendees). A meeting invite may indicate a date, a time, a location, a duration, an agenda, etc. of the meeting. The meeting invite may further seek an acknowledgement from an attendee regarding their attendance status, providing options to accept, decline, or mark their presence as tentative.

In some embodiments, where the meeting attendees also include visitors (e.g., external attendees), a visitor management process is automatically triggered or initiated. The visitor management process may be executed by the visitor management system 102 to process various tasks such as creating new visits, sending premise entry invites, reserving parking spots, lockers, etc. for the visitors. Upon successful execution of the visitor management process by the visitor management system 102, the meeting scheduling system 108 sends meeting invites (or requests) to the external attendees. A meeting invite sent to an external attendee may additionally include a premise entry invite, details of a parking spot reserved for the external attendee, details of a locker reserved for the external attendee, and/or the like.

In some embodiments, the meeting scheduling service or application may be further accessed by the meeting host to modify a previously scheduled meeting. In some embodiments, modification of a meeting may include changing at least one meeting parameter associated with the meeting. For example, the meeting host may add new attendees to or remove some of the previously invited attendees from the meeting, change a time, duration, and/or location of the meeting, or the like. In some other embodiments, modification of a meeting may include cancelation of the meeting. For the internal attendees, the meeting scheduling system 108 may send an updated meeting invite with new meeting details. In an embodiment, where the meeting attendees also include visitors (e.g., external attendees), the visitor management process is triggered again. Upon successful execution of the visitor management process by the visitor management system 102, the meeting scheduling system 108 sends updated meeting invites to the external attendees. The updated meeting invite sent to an external attendee may additionally include an updated premise entry invite, updated details of parking reservation, updated details of locker reservation etc. in accordance with the changes in the meeting. For example, if the meeting is rescheduled from 4 PM to 7 PM, the updated meeting invite may indicate premise entry and parking reservation from 7 PM instead of 5 PM. In another scenario, if the meeting is canceled, the external attendee is notified regarding the canceled meeting, and the premise entry invite, and parking reservation are canceled automatically. While some examples described herein may describe modifying and/or creating parking spot reservations, the present disclosure also contemplates several other types of reservations. For example, the present disclosure contemplates systems and methods for reservations of lockers, workstations, cubicles, computing devices, and/or other possible reservable entities of a building.

In some embodiments, the client devices 110 may include user devices of the meeting host, internal attendees the visitors, system operator, or the like. For example, the client device 110 may be utilized by the meeting host to schedule a meeting. The client devices 110 may be utilized by the internal attendees to view meeting invites and provide their attendance status for a scheduled meeting. Further, the client devices 110 may be utilized by the external attendees to view meeting invites and parking reservation information, and provide their attendance status for a scheduled meeting. Examples of the client devices 110 may include smartphones, tablets, phablets, smart wearable devices, laptops, or the like.

In some embodiments, the visitor management system 102 may include suitable logic, circuitry, and/or interfaces to streamline and automate one or more processes of managing visitors and their activities in a building (e.g., the building 114), a premise, a building area, or the like. The visitor management system 102 may act as a centralized system for capturing, storing and managing visitor information, enhancing building security, and improving overall visitor experience. Examples of various tasks executed by the visitor management system 102 may include visitor registration, visitor parking reservations, visitor check-in, host notifications, access control integration, visitor tracking, and/or the like. The visitor management system 102 is further integrated with the BMS 104, the parking management system 106, and the meeting scheduling system 108 to automate the processes of managing visitors.

In some embodiments, the visitor management system 102 may include a network interface 122 to provide access to the network 112. The network interface 122 may be or include wired or wireless communications interfaces (e.g., jacks, antennas, transmitters, receivers, transceivers, wire terminals, etc.) for conducting data communications within the system 100 and/or with other external systems or devices. In various embodiments, communications via the network interface 122 are direct (e.g., local wired or wireless communications). Additionally, or alternatively, communications via the network interface 122 may be via the network 112 (e.g., a WAN, the Internet, a cellular network, etc.). For example, the visitor management system 102 may communicate with the BMS 104, the parking management system 106, the meeting scheduling system 108, using a wired connection and may communicate with the client devices 110 using a cellular connection (e.g., a 4G or 5G access point/small cell base station, etc.). As a further example, the network interface 122 may include an Ethernet card and port for sending and receiving data via an Ethernet-based communications link or network. As a further example, the network interface 122 may include a Wi-Fi transceiver for communicating via a wireless communications network (e.g., the network 112). As yet a further example, the network interface 122 may include cellular or mobile phone communications transceivers. As a result, a user or systems/devices (e.g., the BMS 104, the parking management system 106, the meeting scheduling system 108, the client devices 110) may interface with the visitor management system 102 directly, or remotely through the network 112 or any other method. The visitor management system 102 can be part of or be a computer, workstation, server, a mobile computing device, a smart device, the BMS 104, or other computing device in some embodiments.

In some embodiments, the visitor management system 102 may further include an input/output (I/O) interface 124 and one or more I/O devices 126. The I/O interface 124 may be configured to communicatively couple the visitor management system 102 to one or more peripheral devices through respective pins. Examples of such an I/O interface 124 may include a general purpose input/output (GPIO) devices. Examples of the I/O devices 126 may include a display, a keyboard, a touchscreen, a cursor control device, a computer mouse, or the like.

In some embodiments, the visitor management system 102 may include a database 128. The database 128 may be configured to store information required for handling visitor management processes. For example, the database 128 may store a list of premise occupants 130 and a parking availability list 132. The premise occupants 130 may include the details of various occupants (e.g., employees, residents, or the like) of the building 114. The parking availability list 132 may include parking reservation schedule, parking occupancy schedule, details of available parking spots, or the like. In some embodiments, the parking management system 106 may also facilitate use of unused assigned parking spots. For example, the parking management system 106 may determine that an individual is not planning to use their assigned parking spot (e.g., by detecting an out of office setting on an electronic calendar of the user, by receiving occupancy data from the sensors 118, etc.) during a time period. Such parking spots may be recognized as available in the parking availability list 132 for the duration of unuse.

In some embodiments, the parking availability list 132 may be dynamically updated based on parking related data received from the parking management system 106. For example, when a user parks their vehicle at their dedicated parking spot, status of the parking spot changes from unoccupied to occupied in the parking availability list 132. Similarly, when a user exits the parking lot 116 with their vehicle, status of the parking spot changes from occupied to unoccupied in the parking availability list 132. Further, a parking spot may have been reserved for a visitor from 2 PM to 6 PM on a given date. In such a scenario, the parking spot may remain unavailable for any other reservation between 2 PM to 6 PM on the given date. However, if the visitor's visit gets canceled, the parking spot may become available for a reservation between 2 PM to 6 PM on the given date. In other words, the parking availability list 132 may indicate real-time status of the parking spots in the parking lot 116.

In some embodiments, the visitor management system 102 may further include one or more processors 134 and a memory 136. The processor 134 can be a general purpose or specific purpose processor, an application specific integrated circuit (ASIC), one or more field programmable gate arrays (FPGAs), a group of processing components, or other suitable processing components. The processor 134 may be configured to execute computer code or instructions stored in a memory 136 or received from other computer readable media (e.g., CDROM, network storage, a remote server, etc.).

The memory 136 may include one or more devices (e.g., memory units, memory devices, storage devices, or other computer-readable media) for storing data and/or computer code for completing and/or facilitating the various processes described in the present disclosure. The memory 136 may include random access memory (RAM), read-only memory (ROM), hard drive storage, temporary storage, non-volatile memory, flash memory, optical memory, or any other suitable memory for storing software objects and/or computer instructions. The memory 136 may include database components, object code components, script components, or any other type of information structure for supporting the various activities and information structures described in the present disclosure. The memory 136 may be communicably connected to the processor 134 and may include computer code for executing (e.g., by the processor 134) one or more processes described herein.

In some embodiments, the memory 136 may include an invite manager 138 that coordinates with the meeting scheduling system 108, the parking management system 106, and the BMS 104 to manage visitors. The invite manager 138 may receive a meeting request initiated using the meeting scheduling system 108 by a meeting host. The meeting request may or may not include one or more external attendees (e.g., visitors). The invite manager 138 may identify whether the meeting request includes any external attendees. For example, the invite manager 138 may compare the list of attendees included in the meeting request with the list of premise occupants 130 to identify whether the meeting request includes any external attendees. In a scenario where the meeting request does not include any external attendees, the invite manager 138 may not trigger the visitor management process and may send an instruction to the meeting scheduling system 108 to send meeting invites to all attendees (e.g., internal attendees who are premise occupants). Since the attendees are premise occupants, they may not need any premise entry invite and/or parking reservation. However, if the meeting request includes at least one external attendee (e.g., visitor), the invite manager 138 may send an instruction to the meeting scheduling system 108 to send meeting invites to all internal attendees and automatically trigger the visitor management process to synchronize parking reservation and premise entry invite with meeting parameters for the external attendee.

In some embodiments, to synchronize the premise entry invite with the meeting parameters, the invite manager 138 may determine a meeting schedule of the external attendee and generate a premise entry invite in accordance with the meeting schedule. For example, if the meeting is scheduled for 4 PM-6 PM, the invite manager 138 may create a new visit and generate a premise entry invite that allows the external attendee to enter the premise (e.g., the building 114) and access the meeting room for a duration of 4 PM-6 PM on the set date. The invite manager 138 may include additional buffer time before and after the scheduled meeting time to ensure that the external attendee does not face any issue while entering the building 114, especially when they arrive early. Further, the invite manager 138 may check if the external attendee has other meetings scheduled for the same day. If the invite manager 138 determines that the external attendee also has other meetings scheduled for the same day, the invite manager 138 may modify a previously generated entry invite for the external attendee to also cover the newly scheduled meeting or may generate a new entry invite that is based on an aggregate or combined meeting schedule of all the meetings. In other words, the invite manager 138 automatically aggregates the meetings of the external attendee in the building 114 and manages a single visit invitation (e.g., premise entry invite) that can accommodate each of the meetings.

In some embodiments, when the external attendee requires a parking spot to park their vehicle as indicated by the meeting host, the invite manager 138 may synchronize the parking reservation with the meeting parameters for the external attendee. For synchronizing the parking reservation with the meeting parameters, the invite manager 138 may coordinate with the parking management system 106. The invite manager 138 in coordination with the parking management system 106 may determine an available parking spot in the parking lot 116 that can accommodate the meeting schedule of the external attendee.

As an example, if the meeting is scheduled for 4 PM-6 PM, the invite manager 138 may select a parking spot that is available for a duration of 4 PM-6 PM on the set date. The invite manager 138 may also include the additional buffer time before and after the scheduled meeting time to ensure that the external attendee does not face any issues while parking, especially when they arrive early or when the meeting is extended. In other words, the invite manager 138 may set a parking reservation time period based on a meeting duration identified in the meeting request and the buffer time.

In some embodiments, the invite manager 138 may utilize the parking availability list 132 to select a parking spot that is available for a required duration (or time period). In some embodiments, the invite manager 138 may also check a previous parking history of the external attendee and if any of the previously assigned parking spots is available, the invite manager 138 may select the same parking spot for reservation. In some embodiments, the invite manager 138 may check if the external attendee has other meetings scheduled for the same day, and parking has been reserved for those meetings. If the invite manager 138 determines that the external attendee also has other meetings scheduled for the same day with reserved parking, the invite manager 138 may extend the parking duration to accommodate the newly scheduled meeting.

In some embodiments, the invite manager 138 may determine that the parking spot reserved for the other scheduled meetings of the external attendee is already reserved for a subsequent visitor. In such a scenario, the invite manager 138 can automatically select a new parking spot based on an aggregate or combined meeting schedule of all the meetings including the newly scheduled meeting. However, if the new meeting is spaced apart in time from the previously scheduled meetings, the invite manager 138 can select a different parking spot for the new meeting. In other words, the invite manager 138 in coordination with the parking management system 106 may apply one or more optimization techniques to maximize the utility of parking lot 116 and also make the visit of the external attendee seamless with regards to parking.

In some embodiments, once the parking spot is selected, the invite manager 138 may send an instruction to the parking management system 106 to reserve the parking spot for the external attendee. The invite manager 138 may define reservation criteria, for example, date, time, duration, etc. for the parking reservation. The invite manager 138 may further provide the details of the vehicle, the external attendee, or the like to the parking management system 106 so that the parking management system 106 can identify and guide the external attendee when they arrive.

In some embodiments, upon handling of all visitor managements tasks, the invite manager 138 may send an instruction to the meeting scheduling system 108 to send a meeting invite to the external attendee which includes the details of the meeting, the premise entry invite, the parking reservation, and other access control details. Based on the instruction, the meeting scheduling system 108 may send the meeting invite to the external attendee. In other words, the invite manager 138 may cause the meeting scheduling system 108 to transmit a notification to the external attendee regarding the parking reservation and/or the premise entry invite. The meeting invite may further seek an acknowledgement from the external attendee regarding their attendance status, providing options to accept, decline, or mark their presence as tentative. Further, the meeting invite may seek an acknowledgement from the external attendee regarding their parking status, providing options to accept, decline, or mark the parking requirement as tentative. The meeting scheduling system 108 may communicate the acknowledgement received from the external attendee to the invite manager 138. The invite manager 138 can accordingly make changes to the parking reservation and the premise entry invite. For example, if the external attendee declines attending the meeting, the invite manager 138 may automatically cancel the premise entry invite and the parking reservation generated for the duration of the meeting. In case the external attendee has other meetings scheduled for the same day, the premise entry invite, and the parking reservation may remain intact for those meeting and may only be canceled for the meeting declined by the external attendee.

In some embodiments, the invite manager 138 may receive a notification from the parking management system 106 when the external attendee arrives and parks the vehicle at the reserved parking spot. The invite manager 138 may then inform an interested party (e.g., the meeting host, an escort, a lobby receptionist, or the like) regarding the arrival of the external attendee. The invite manager 138 may send an instruction to the BMS 104 to specify the access criteria set for the external attendee.

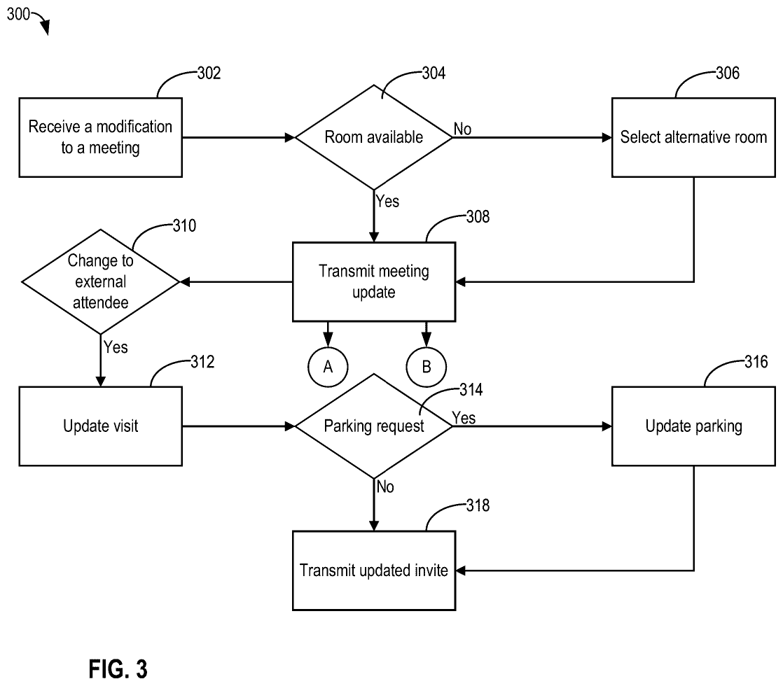

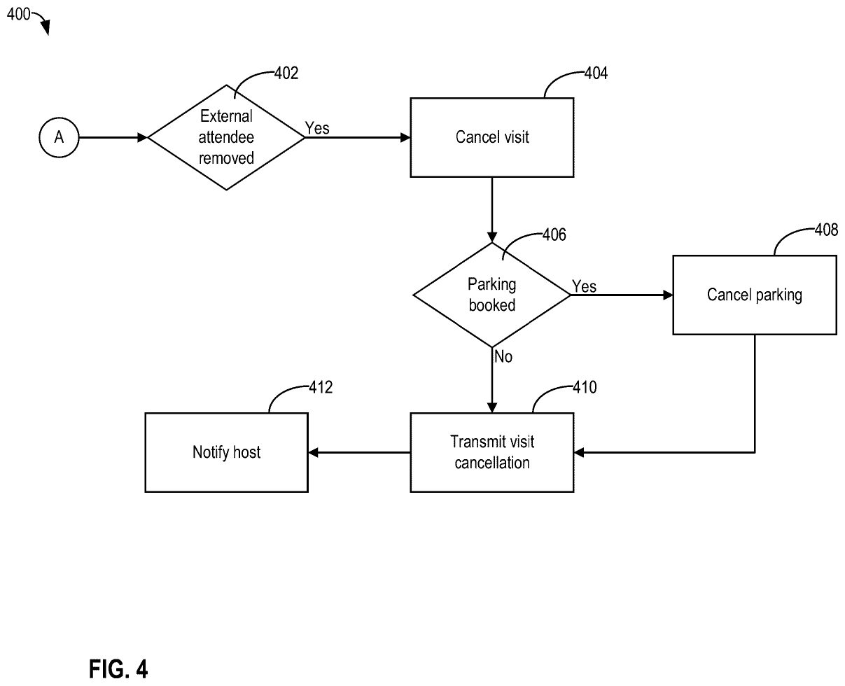

In some embodiments, the meeting host may modify one or more meeting parameters of a scheduled meeting. In such a scenario, the invite manager 138 may receive a modification in the meeting parameter of the meeting request. If any of the modified meetings include an external attendee as a participant, the invite manager 138 may again trigger the visitor management process to synchronize the parking reservation, premise entry invite, and or the like with modified meeting parameters for the external attendee (e.g., update at least one of the parking reservation and the premise entry invite based on the modification). Synchronization of the parking reservation and the premise entry invite with modified meeting parameters is described later in conjunction with FIGS. 3A-3B and 4.

In some embodiments, the invite manager 138 may be configured to automatically notify (e.g., transmit a notification) the external attendee regarding any changes made to the meeting parameters and in turn the parking reservation and the premise entry invite without any manual intervention. In other words, the invite manager 138 may cause the meeting scheduling system 108 to transmit a notification regarding the updated parking reservation and the updated premise entry invite to the external attendee. Thus, the parking reservation and the premise entry invite always remain in synchronization with the meeting, resulting in a seamless visitor experience.

In some embodiments, the client devices 110 may access a notification service provided by the visitor management system 102 to facilitate two-way communication between individuals and the visitor management system 102. For example, the visitor management system 102 may send a notification to an employee indicating that a guest (e.g., visitor) of the employee has arrived at the parking lot 116, may receive a response from the employee (e.g., a personalized message, etc.), and may cause the parking management system 106 to display the response to the guest (e.g., via the user interface devices installed at the parking lot 116). The user interface devices may include kiosks.

In some embodiments, the visitor management system 102 may notify a user (e.g., a visitor) regarding expiration of their parking reservation, (e.g., when their parking time is about to expire). In an example, an external attendee may have a two hour parking reservation, the parking management system 106 may determine that the parking reservation will expire in ten minutes and the vehicle of the external attendee is still parked at the reserved parking spot. In such a scenario, the parking management system 106 may notify the visitor management system 102. In response, the visitor management system 102 may generate an alert, before the predetermined time period from the meeting end time, to notify (e.g., a text-message, a push notification, etc. to the client device 110) the external attendee indicating that the parking reservation is about to expire.

In some embodiments, when the parking spot is not reserved for a subsequent user, the visitor management system 102 may provide an option to the external attendee to extend the parking reservation for a predetermined time based on parking availability. The external attendee may accept or decline the parking extension option. The visitor management system 102 may extend the parking reservation upon receiving a confirmation from the external attendee or the meeting host. However, in another scenario when the parking spot is already reserved for a subsequent user, the visitor management system 102 may provide a reminder to the external attendee to vacate the parking spot. In case the external attendee requires another parking spot due to extension of the meeting, the visitor management system 102 may automatically assign a new parking spot to the external attendee for the extended time or may update the parking reservation of the subsequent user to a new parking spot. In some embodiments, the external attendee may not vacate the parking spot even after the expiration of the reservation time period. In such a scenario, the visitor management system 102 may generate an overstay alert and transmit the alert to the external attendee and/or the meeting host.

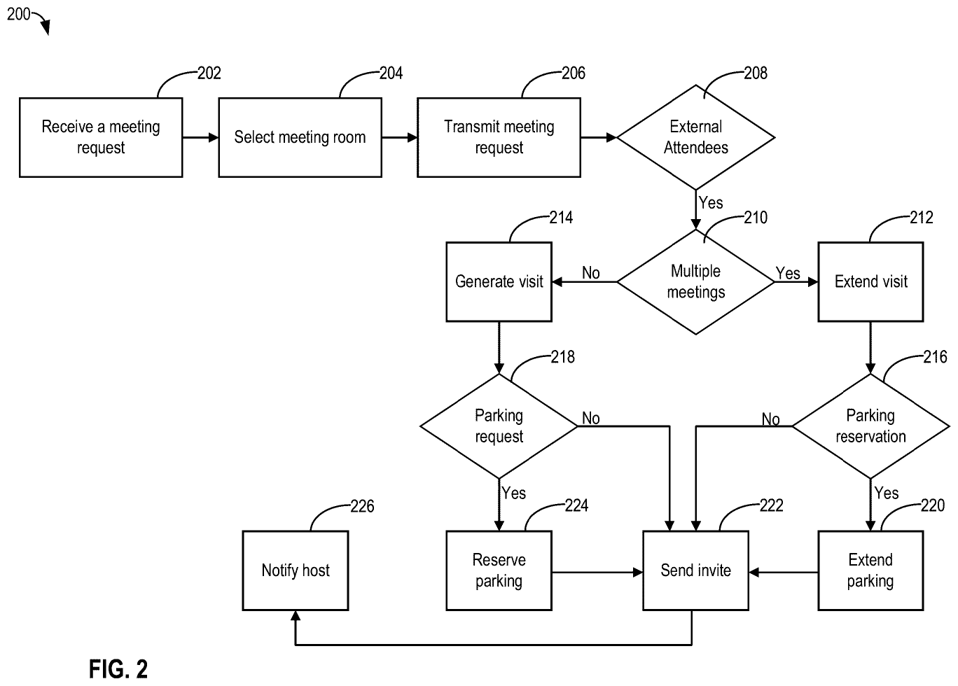

FIG. 2 depicts a flow chart of a method 200 to automatically manage visits of external attendees, according to some embodiments. For example, when a new meeting is scheduled, the visitor management system 102 may automatically check if any external attendees (e.g., visitors) have been added to the meeting. If so, the visitor management system 102 may arrange a visit for each of these visitors. An individual visitor might have been invited to attend more than one meeting on the same day. In such a scenario, the visitor management system 102 may automatically aggregates the meetings and extends the existing visit.

In some embodiments, the visitor management system 102 may determine if the meeting host has the authority to allocate visitor parking and has requested visitor parking for the visitor. Based on the parking availability, the visitor management system 102 may reserve a parking spot for the visitor and allows a buffer before and after the meeting to allow for time to get to and from the parking lot 116. If the visitor already has parking reserved for a previous meeting, the visitor management system 102 may automatically extend the reservation or allocates a new parking spot for the duration of all meetings. Based on successful parking reservation, the visitor management system 102 may send a meeting invite including the details of the meeting, location, entry invite, and parking. In some embodiments, the visitor management system 102 may notify the meeting host that the visitor has been invited and that parking has been reserved.

In some embodiments, the method 200 and/or one or more steps thereof may be performed by at least one of the various systems, devices, and/or components described herein. For example, the visitor management system 102 may perform the method 200. As another example, the meeting scheduling system 108 may perform at least one step of the method 200. In some embodiments, the method 200 and/or one or more steps thereof may be replicated, reproduced, repeated, and/or otherwise duplicated. The method 200 and/or one or more steps thereof may be omitted, separated, modified, adjusted, and/or otherwise changed.

In some embodiments, at step 202, a meeting request may be received. For example, the meeting scheduling system 108 may receive at least one meeting request from the client device 110. As another example, the meeting scheduling system 108 may receive at least one meeting request responsive to a selection of one or more elements included in a user interface. In some embodiments, the meeting request may include at least one the various meeting requests described herein. For example, the meeting request may include meeting parameters to define one or more meetings.

In some embodiments, at step 204, a meeting room may be selected. For example, the meeting scheduling system 108 may select a meeting room based on the meeting request received in step 202. In some embodiments, the meeting scheduling system 108 may select the meeting room based on at least one of host permissions, room availability, room capacity, and resources. For example, the meeting scheduling system 108 may select a meeting room based on a permission associated with the host allowing for the meeting room to be reserved.

In some embodiments, at step 206, the meeting request may be transmitted. For example, the meeting scheduling system 108 may transmit the meeting request to the visitor management system 102. As another example, the meeting scheduling system 108 may transmit the meeting request to the client devices 110. In some embodiments, the meeting scheduling system 108 may include the meeting parameters in the transmission of the meeting request.

In some embodiments, at step 208 a determination as to whether the meeting request includes external attendees may be determined. For example, the meeting scheduling system 108 may determine if the meeting request, received in step 202, identifies and/or indicates any visitors (e.g., external attendees) for the meeting. In some embodiments, the method 200 may terminate and/or pause until a subsequent meeting request is received. In other embodiments, the method 200 may proceed to step 210, responsive to a determination that the meeting request includes external attendees.

In some embodiments, at step 210 a determination as to whether an external attendee has multiple meetings may be determined. For example, the meeting scheduling system 108 may determine if an external attendee, identified in step 208, has been invited to multiple meetings. In some embodiments, the method 200 may proceed to step 212 responsive to a determination that the external attendee was invited to multiple meetings. In some embodiments, the method 200 may proceed to step 214 responsive to a determination that the external attendee was invited to a single meeting.

In some embodiments, at step 212, a visit may be extended. For example, the meeting scheduling system 108 may extend a visit for an external attendee determined to have multiple meetings. As another example, the meeting scheduling system 108 may extend visits for external attendees identified as having multiple meetings in step 210. In some embodiments, at step 214, a visit may be generated. For example, the meeting scheduling system 108 may generate a visit for an external attendee that has a single meeting as determined in step 210.

In some embodiments, at step 216, a determination as to whether an extended visit includes a parking reservation may be determined. For example, the meeting scheduling system 108 may extract information from a visit, generated for the external attendee, to determine if parking was reserved. In some embodiments, the method 200 may proceed to step 222 responsive to a determination that the external attendee does not have a parking reservation. In some embodiments, the method 200 may proceed to step 220 responsive to a determination that the external attendee has a parking reservation.

In some embodiments, at step 218, a determination as to whether a generated visit includes a parking reservation may be determined. For example, the meeting scheduling system 108 may extract information from the visit generated in step 214. In some embodiments, the meeting scheduling system 108 may extract the information to determine if the visit includes an indication of a parking request. In some embodiments, the method 200 may proceed to step 222 responsive to a determination that the visit does not include a parking request. In some embodiments, the method 200 may proceed to step 224 responsive to a determination that the visit includes a parking request.

In some embodiments, at step 220, a parking reservation may be extended. For example, the meeting scheduling system 108 may extend a parking reservation in accordance with the visit extended in step 212. In some embodiments, at step 222, an invite may be sent. For example, the meeting scheduling system 108 may transmit an invite to a computing device (e.g., client devices 110) associated with an external attended indicated in the visit generated in step 214 and/or the visit extended in step 212. In some embodiments, at step 224, parking may be reserved. For example, the meeting scheduling system 108 may reserve parking for one or more visits that were determined to have parking requests in step 218.

In some embodiments, at step 226 a host may be notified. For example, the visitor management system 102 in coordination with the meeting scheduling system 108 may notify the meeting host that all attendees (including the internal and external attendees) are invited for the meeting. As another example, the visitor management system 102 may notify the meeting host regarding the acknowledgements shared by the attendees.

FIG. 3 depicts a flow chart of a method 300 to automatically synchronize an external attendee visit with updated meeting parameters, according to some embodiments of the present disclosure. For example, the method 300 may be implemented to re-schedule a meeting and/or change the meeting, such as change the time or location, add new attendees, remove previously added attendees. In some embodiments, the method 300 may include rearrangement of visits for one or more external attendees for the meeting.

In some embodiments, the method 300 and/or one or more steps thereof may be performed by at least one of the various systems, devices, and/or components described herein. For example, the visitor management system 102 may perform the method 300. As another example, the meeting scheduling system 108 may perform at least one step of the method 300. In some embodiments, the method 300 and/or one or more steps thereof may be replicated, reproduced, repeated, and/or otherwise duplicated. The method 300 and/or one or more steps thereof may be omitted, separated, modified, adjusted, and/or otherwise changed.

In some embodiments, at step 302, a modification to a meeting may be received. For example, the meeting scheduling system 108 may receive a modification to meeting from the client devices 110. In some embodiments, the meeting scheduling system 108 may receive the modification to the meeting responsive to one or more changes to the meeting parameters.

In some embodiments, at step 304, a determination as to whether a room is available may be determined. For example, the modification to the meeting, received in step 302, may include a change to the time of the meeting. In this example, the meeting scheduling system 108 may determine if the room reserved, for the original time of the meeting, is still available for the new time. As another example, the modification to meeting may include a change to the room for the meeting. In some embodiments, the method 300 may proceed to step 306 responsive to a determination that the room is not available. In some embodiments, the method 300 may proceed to step 308 responsive to a determination that the room is available.

In some embodiments, at step 306 an alternative room may be selected. For example, the meeting scheduling system 108 may select a room from a list of rooms indicated as being available during the time of the meeting. As another example, the visitor management system 102 may select a new meeting room based on host permissions, room capacity, room availability, and resources.

In some embodiments, at step 308 a meeting update may be transmitted. For example, the visitor management system 102 may send an updated meeting request (or invites) to attendees included as participants in the updated meeting request. In some embodiments, at step 310, a determination as to whether a change to an external attendee occurred may be made. For example, the visitor management system 102 may determine whether the updated meeting request includes any previous external attendees. In some embodiments, the method 300 may pause and/or wait a subsequent receipt of a modification to a meeting responsive to a determination that the updated meeting request does not include any previous external attendees. In some embodiments, the method 300 may proceed to step 312, responsive to a determination that the updated meeting request includes previous external attendees.

In some embodiments, at step 312, a visit may be updated. For example, the visitor management system 102 may update a visit for an external attendee impacted by the modification to the meeting. As another example, the visitor management system 102 may update a visit to adjust and/or changes meeting parameters to reflect the modification to the meeting. In some embodiments, at step 314, a determination as to whether a visit includes a parking request may be made. For example, the visitor management system 102 may determine if the visit updated in step 312 includes a parking request. In some embodiments, the method 300 may proceed to step 316 responsive to a determination that the visit includes a parking request. In some embodiments, the method 300 may proceed to step 318 responsive to a determination that the visit does not include a parking request.

In some embodiments, at step 316, parking may be updated. For example, the visitor management system 102 may update a parking reservation for an external attendee based on the modification to the meeting received in step 302. The visitor management system 102 may update the parking reservation by adding additional time to the parking reservation, by reserving a subsequent parking spot, and/or by providing a notification to parking services.

In some embodiments, at step 318, an updated invite may be transmitted. For example, the visitor management system 102 may transmit an updated invite to a computing device associated with one or more external attendees impacted by the modification to the meeting. In some embodiments, the updated invite may include information associated with the updated parking reservation. For example, the updated invite may identify a subsequent parking spot. As another example, the updated invite may identify a new expiration time for the parking reservation.

FIG. 4 depicts a flow diagram of a method 400 to automatically synchronize an external attendee visit with updated meeting parameters, according to some embodiments of the present disclosure. For example, the method 400 may be implemented to re-schedule a meeting and/or change the meeting, such as change the time or location, add new attendees, remove previously added attendees. In some embodiments, the method 400 may include rearrangement of visits for one or more external attendees for the meeting.

In some embodiments, at step 402, a determination as to whether an external attended has been removed may occur. For example, the visitor management system 102 may determine if the modification to the meeting, received in step 302, included the removal of an external attendee from the meeting. In some embodiments, the method 400 may proceed to step 404 responsive to a determination that an external attendee was removed from the meeting. In some embodiments, the method 400 may pause and/or terminate responsive to a determination that an external attendee was not removed from the meeting.

In some embodiments, at step 404, a visit may be cancelled. For example, the visitor management system 102 may cancel a visit associated with an external attendee that was removed from a meeting. In some embodiments, at step 406, a determination was to whether a parking was booked may be made. For example, the visitor management system 102 may determine whether the visit, cancelled in step 404, was associated with and/or included a parking reservation. In some embodiments, the method 400 may proceed to step 408 responsive to a determination that the visit included a parking reservation. In some embodiments, the method 400 may proceed to step 410 responsive to a determination that the visit did not include a parking reservation.

In some embodiment, at step 408, parking may be cancelled. For example, the visitor management system 102 may cancel a parking reservation associated with an external attendee that was removed from a meeting. As another example, the visitor management system 102 may inform the parking management system 106 that a given parking reservation can be cancelled. In some embodiments, at step 410, a visit cancellation may be transmitted. For example, the visitor management system 102 may transmit one or more signals to a computing device associated with the external attendee to provide confirmation of the cancelled visit.

In some embodiments, at step 412, a host may be notified. For example, a host of the meeting that included the removal of the external attendee may be provided confirmation of when the visit was cancelled. As another example, the host may be provided confirmation of when the external attendee provided indication of receipt of the visit cancellation.

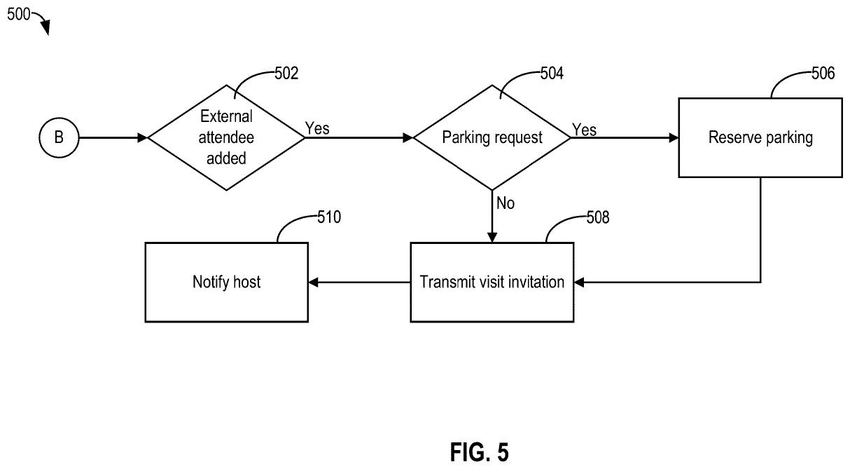

FIG. 5 depicts a flow chart of a method 500 to automatically synchronize an external attendee visit with updated meeting parameters, according to some embodiments of the present disclosure. For example, the method 500 may be implemented to re-schedule a meeting and/or change the meeting, such as change the time or location, add new attendees, remove previously added attendees. In some embodiments, the method 500 may include rearrangement of visits for one or more external attendees for the meeting.

In some embodiments, at step 502, a determination as to whether an external attended has been added may occur. For example, the visitor management system 102 may determine if the modification to the meeting, received in step 302, included an addition of an external attendee from the meeting. In some embodiments, the method 500 may proceed to step 504 responsive to a determination that an external attendee was added to the meeting. In some embodiments, the method 500 may pause and/or terminate responsive to a determination that an external attendee was not added to the meeting.

In some embodiments, at step 504, a determination as whether an external attendee requested parking may be made. For example, the visitor management system 102 may determine if the external attendee, identified in step 502, has request parking. As another example, the visitor management system 102 may determine if the modification to the meeting, received in step 302, provides an indication of a parking request. In some embodiments, the method 500 may proceed to step 506 responsive to determination that a parking request was made. In some embodiments, the method 500 may proceed to step 508 responsive to a determination that a parking request was not made.

In some embodiments, at step 506, parking may be reserved. For example, the visitor management system 102 may reserve parking for the external attendee identified in step 502. As another example, the visitor management system 102 may interface with the parking management system 106 to generate a parking reservation. In some embodiments, at step 508, a visit invitation may be transmitted. For example, the visitor management system 102 may transmit one or more signals to a computing device associated with the external attendee to provide confirmation of the visit. As another example, the visitor management system 102 may transmit one or more signals to cause the computing device to display a user interface that includes information associated with the visit.

In some embodiments, at step 510, a host may be notified. For example, a host of the meeting that added the external attendee may be provided confirmation of when the visit was created. As another example, the host may be provided confirmation of when the external attendee provided indication of receipt of the visit.

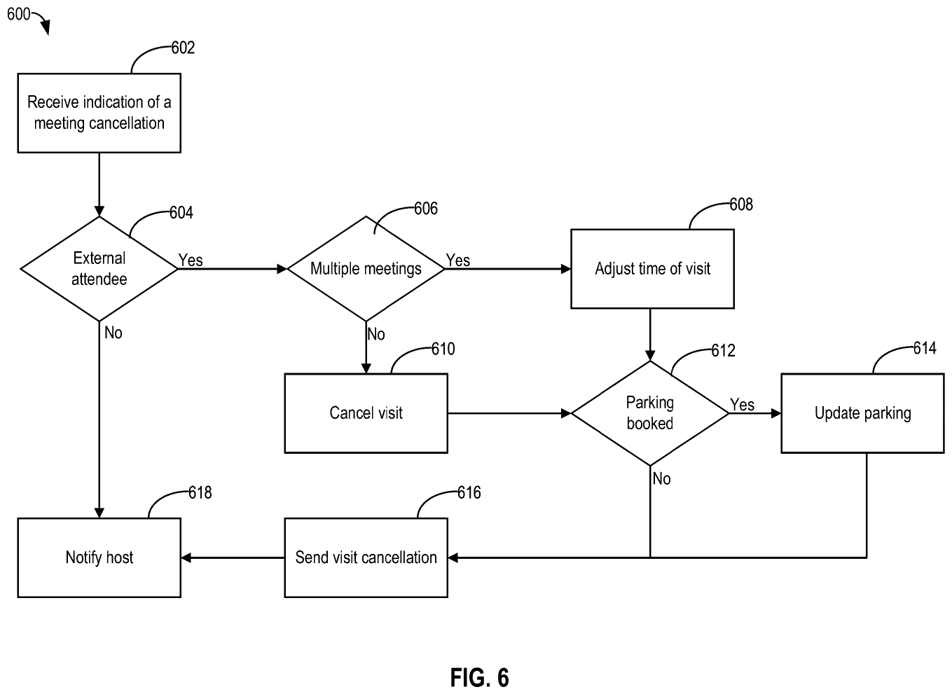

FIG. 6 is a flow chart of a method 600 to automatically cancel an external attendee visit when a meeting is canceled or when the external attendee is removed from the meeting, according to some embodiments. In some embodiments, the method 600 and/or one or more steps thereof may be performed by at least one of the various systems, devices, and/or components described herein. For example, the visitor management system 102 may perform the method 600. As another example, the meeting scheduling system 108 may perform at least one step of the method 600. In some embodiments, the method 600 and/or one or more steps thereof may be replicated, reproduced, repeated, and/or otherwise duplicated. The method 600 and/or one or more steps thereof may be omitted, separated, modified, adjusted, and/or otherwise changed.

In some embodiments, at step 602, an indication of a meeting cancellation may be received. For example, the meeting scheduling system 108 may receive an indication of a meeting cancellation from a computing device associated with a host of the meeting. In some embodiments, at step 604, a determination of whether an external attendee was included in the cancelled meeting may occur. For example, the meeting scheduling system 108 may determine if the meeting, cancelled in step 602, included any external attendees. In some embodiments, the method 600 may proceed to step 618 responsive to a determination that the cancelled meeting did not include any external attendees. In some embodiments, the method 600 may proceed to step 606 responsive to a determination that the cancelled meeting included external attendees.

In some embodiments, at step 606, a determination as to whether an external attendee was invited to multiple meetings may be determined. For example, the meeting scheduling system 108 may determine if the external attendees, identified in step 604, were included in multiple meetings. In some embodiments, the method 600 may proceed to step 608 responsive to a determination that the external attendees were invited to multiple meetings. In some embodiments, the method 600 may proceed to step 610 responsive to a determination that the external attendees were not invited to multiple meetings.

In some embodiments, at step 608, an amount of time for a visit may be adjusted. For example, the cancelled meeting, as indicated in step 602, may have been a first scheduled meeting for the external attendee. In this example, the meeting scheduling system 108 may adjust an arrival time for the external attendee. As another example, the meeting scheduling system 108 may adjust access credentials for the external attendee. In some embodiments, at step 610, a visit may be cancelled. For example, the meeting scheduling system 108 may cancel visits for one or more external attendees based on the external attendees only having been invited to the cancelled meeting. As another example, the meeting scheduling system 108 may deactivate and/or cancel access credentials that may have been generated for the external attendees.

In some embodiments, at step 612, a determination as to whether parking was booked may be made. For example, the meeting scheduling system 108 may determine if the visits, cancelled in step 610, included and/or indicated any parking reservations. As another example, the meeting scheduling system 108 may determine if any of the visits, adjusted in step 608, included parking reservations. In some embodiments, the method 600 may proceed to step 614 responsive to a determination that a visit included a parking reservation. In some embodiments, the method 600 may proceed to step 616 responsive to a determination that a visit did not include a parking reservation.

In some embodiments, at step 614, parking may be updated. For example, the meeting scheduling system 108 may interface with the parking management system 106 to cancel parking reservations in the parking lot 116. As another example, the meeting scheduling system 108 may interface with the parking management system 106 to adjust (e.g., shorten, extend, etc.) parking reservations in the parking lot 116. In some embodiments, at step 616, a visit cancellation may be sent. For example, the meeting scheduling system 108 may send a visit cancellation to one or more attendees impacted by the meeting cancelled in step 602. As another example, the meeting scheduling system 108 may transmit one or more signals to cause a display device located within the building 114 to display a message to indicate the cancelled meeting. In some embodiments, at step 618, a host may be notified. For example, the meeting scheduling system 108 may transmit signals to a computing device associated with the host of the cancelled meeting. As another example, the meeting scheduling system 108 may transmit signals to computing device to cause the computing device to display a user interface that includes confirmation of the cancelled meeting.

In some embodiments, the visitor management system 102 may integrate with various building systems (e.g., BMS 104, parking management system 106, meeting scheduling system 108, or the like) or third-party systems or applications to provide visitor management solutions. The visitor management system 102 may include flexible logic to drive given outcomes. In some embodiments, instead of being integrated with different building systems, the visitor management system 102 may provide a one-stop solution by incorporating the functionalities of different building systems.

In some embodiments, the visitor management system 102 may be integrated with an enterprise identity provider to enable seamless single sign-on and authentication of meeting hosts. The visitor management system 102 may be integrated with enterprise HR or eligibility system, so that employees of an organization may be given either individual or role-based permissions to invite guests and to reserve parking and other visitor services on behalf of visitors. The visitor management system 102 may be integrated with other enterprise systems which offer bookable visitor services. Examples of this may include dining services, visitor lockers, cycle lockers, hot-desks, or the like.

In some embodiments, the visitor management system 102 may include for managing visits and visitors. If the same visitor is invited for multiple visits on the same day by the same or different hosts, the visitor management system 102 may aggregate multiple meetings and manage the combined visit. If one of these meetings is subsequently canceled, the visitor management system 102 may trim the visit accordingly. If the meetings are separated, the visitor management system 102 may split the visit into two or more separate visits and reschedule the parking and other visitor services accordingly. The advantage of this flexible workflow logic is to manage the enterprise resources efficiently and to provide an improved visitor experience.

In some embodiments, the visitor management system 102 may also provide valuable analytical information that may be used by a facility manager to monitor and optimize the use of resources such as meeting-rooms, parking spots, and other visitor resources. These analytics can also be used to ensure that visitors receive a streamlined visitor experience.

The visitor management system 102 may manage visitor invitations and parking reservations for meetings automatically and does not require multiple manual processes. Additionally, the visitor management system 102 may synchronize visits and parking reservations with the meeting invitation. The visitor management system 102 may combine multiple meetings on the same day to create a single visit, improving the user experience for the visitor. The visitor management system 102 may cancel visits and parking reservations automatically when the meeting is canceled, ensuring that valuable parking spaces are released when not required.

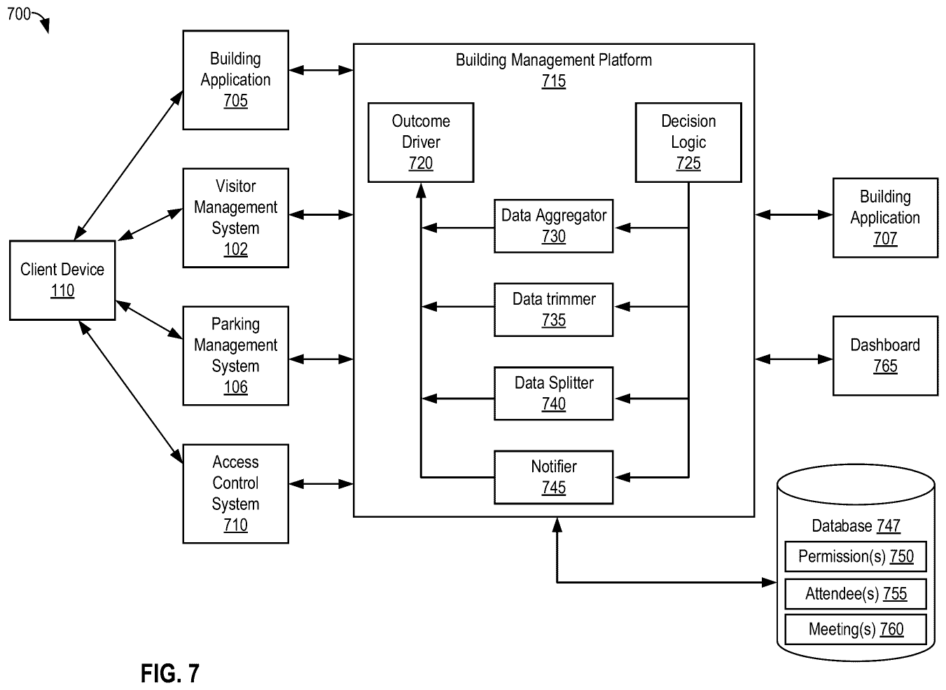

FIG. 7 is a block diagram of system 700 to provide meeting integration for a Building Management System, according to some embodiments. In some embodiments, at least one the systems, devices, and/or components may be integrated with and/or included in the system 700. For example, a shown in FIG. 7, the system 700 includes the client devices 110, the visitor management system 102, and the parking management system 106. As another example, at least one of the systems, devices, and/or components described herein may implement the system 700. In some embodiments, one or more systems, devices, and/or components of the system 700 may communicate with one another via the network 112. The system 700 and/or one or more portions thereof may represent an integrated meeting management system. For example, the system 700 may integrate and/or group one or more standalone or isolated systems into a collection of systems that interface with one another.

In some embodiments, the system 700 may include at least one building application 705, at least one building application 707, at least one access control system 710, at least one building management platform 715, at least one at least one database 747, and at least one dashboard 765. As shown in FIG. 7, the building management platform 715 may serve as a gateway between one or more systems, devices, and/or components of the system 700. For example, the building management platform 715 may serve as a gateway between the visitor management system 102 and the parking management system 106 such that the two systems may be integrated with one another.

In some embodiments, the building application 705 may be stored and/or otherwise located on the client devices 110. For example, the building application 705 may be a mobile application stored in memory of the client devices 110. As another example, the building application 705 may be a website or other online platform that the client device 110 may interface with. In some embodiments, the building application 705 may include at least one information manager, such as an email client, an email management computer program, a scheduling software, and/or other possible web applications that process or manage emails.

In some embodiments, the building application 707 may perform similar operations to that of the building application 705. For example, the building application 707 may include an information manager. In some embodiments, the building application 707 may include one or more services and features discrete from the building application 705. For example, the building application 707 may interface with the visitor management system 102 to reserve a given conference. Conversely, the building application 705 may only be able to provide information about where a given meeting was scheduled. Stated otherwise, the building application 705 may have read access to information associated with one or more meetings of a building and the building application 707 may include read and write access to information associated with one or more meetings of the building.

In some embodiments, the dashboard 765 may include at least one of a kiosk, an interactive monitor, a display screen, and/or a display interface. The dashboard 765 may be disposed and/or located one or more locations within and/or proximate to the building 114. For example, the dashboard 765 may be located proximate to an entrance of the building 114. As another example, the dashboard 765 may be located proximate to a conference room. In some embodiments, the dashboard 765 may display and/or present information associated with one or more meetings for a building. For example, the dashboard 765 may display information to indicate when a given external attendee has arrived at the building 114.

In some embodiments, the database 747 may refer to and/or include at least one of a server bank, a remote storage device, a cloud-based computing system, and/or other possible remote device. While FIG. 7 shows the database 747 to be separate from the building management platform 715, in some embodiments, the database 747 may be integrated with and/or included in the building management platform 715. In some embodiments, the database 747 may store and/or maintain the various types of information described herein. For example, the database 747 may maintain information that indicates one or more parking reservations at the parking lot 116. As another example, the database 747 may maintain information that indicates one or more meetings and/or visits for the building 114.

In some embodiments, the database 747 may store and/or maintain information that indicates and/or represents permissions 750, attendees 755, and meetings 760. For example, the database 747 may store the information as one or more data structures. In some embodiments, the permissions 750 may indicate and/or represent authorizations and/or approvals that a given entity of the building 114 has when scheduling meetings 760. For example, a given permission 750 for an entity may indicate that the entity is approved to reserve a conference room on a given floor of the building. As another example, the given permission 750 for the entity may indicate one or more parking spots that the entity is able to reserve. In some embodiments, the permissions 750 may represent what type of services an entity may reserve for the attendees 755. For example, a given permission 750 may indicate that an entity is able to reserve parking in a given lot for the attendees 755. As another example, the given permission 750 may indicate that the entity may reserve a given workstation for the attendees 755. In some embodiments, the attendees 755 may refer to and/or include external attendees invited to one or more meetings at the building 114. The meetings 760 may refer to and/or include one or more meetings scheduled at the building 114.

In some embodiments, the building management platform 715 may include at least one outcome driver 720, at least one decision logic 725, at least one data aggregator 730, at least one data trimmer 735, at least one data splitter 740, and at least one notifier 745. The various systems, devices, and/or components of the building management platform 715 may store as instructional code (e.g., firmware, software, computer code, etc.) that cause the building management platform 715 to perform at least one of the processes and/or actions described herein.

In some embodiments, the decision logic 725 may route and/or forward one or more types of information. For example, the decision logic 725 may forward information provided to the building management platform 715 to at least one of the data aggregator 730, the data trimmer 735, the data splitter 740, and/or the notifier 745. As another example, the decision logic 725 may forward information associated with the meetings 760 and/or one or more requests for given meetings 760. In some embodiments, the decision logic 725 may receive one or more indications of adjustments and/or modifications to the meetings 760. For example, the decision logic 725 may receive an indication, from the building application 707, that a given meeting 760 was cancelled. As another example, the decision logic 725 may receive an indication that a given meeting 760 was moved from a first room to a second room of the building 114.

In some embodiments, the decision logic 725 may forward a modification and/or adjustment to a given meeting 760 to a given component of the building management platform 715 based on the change to the given meeting 760. For example, the decision logic 725 may forward information to the notifier 745 when the information represents a cancellation of a given meeting 760. As another example, the decision logic 725 may forward information to the data aggregator 730 when a new meeting 760 has been created.

In some embodiments, the data aggregator 730 may combine and/or otherwise merge one or more visits. For example, the data aggregator 730 may merge one or more visits for a given attendee 755. As another example, the data aggregator 730 may merge visits for a given attendee 755 that has multiple meetings 760 for the same day at the building 114. In some embodiments, the data aggregator 730 may merge visits to be prevent one or more duplicative processes. For example, the data aggregator 730 may merge visits to prevent the parking management system 106 from reserving more than one parking spot for a given attendee 755. Stated otherwise, if multiple visits for the given attendee 755 were not merged the parking management system 106 may reserve multiple parking spots for the given attendee 755.

In some embodiments, the data trimmer 735 may truncate or remove one or more portions of a visit. For example, the data trimmer 735 may truncate a visit by shortening and/or adjusting a duration of the visit. In some embodiments, the data trimmer 735 may truncate a visit when one or more meetings are cancelled and/or rescheduled. For example, the data trimmer 735 may truncate a visit for a given attendee 755 as a result of a meeting being cancelled. Stated otherwise, the data trimmer 735 may remove, from a visit, information that represents a given meeting 760 responsive to cancellation of the given meeting 760. In some embodiments, the data trimmer 735 may truncate a visit when the visit is associated with multiple meetings 760. For example, if a given visit is associated with a first meeting 760 and a second meeting 760, the data trimmer 735 may truncate the given visit responsive to a cancellation of the first meeting 760 and/or the second meeting 760.

In some embodiments, the data splitter 740 may separate and/or otherwise divide one or more visits. For example, the data splitter 740 may separate one or more meetings 760 from a first visit to then create a second visit with the meetings 760 separated from the first visit. As another example, the data splitter 740 may create a visit by removing one or more meetings 760 from a second visit and then associated the meetings 760 with the visit. In some embodiments, the data splitter 740 may separate one or more visits responsive to a rescheduling of one or more meetings 760. For example, the data splitter 740 may separate a given visit into two or more visits responsive to the given visit being associated with a rescheduled meeting 760. Stated otherwise, when a given visit has a meeting 760 that was rescheduled, the data splitter 740 may split the given visit into to two visits by removing, from the given visit, the meeting 760 that was rescheduled and generating a new visit that includes the meeting 760 that was rescheduled.

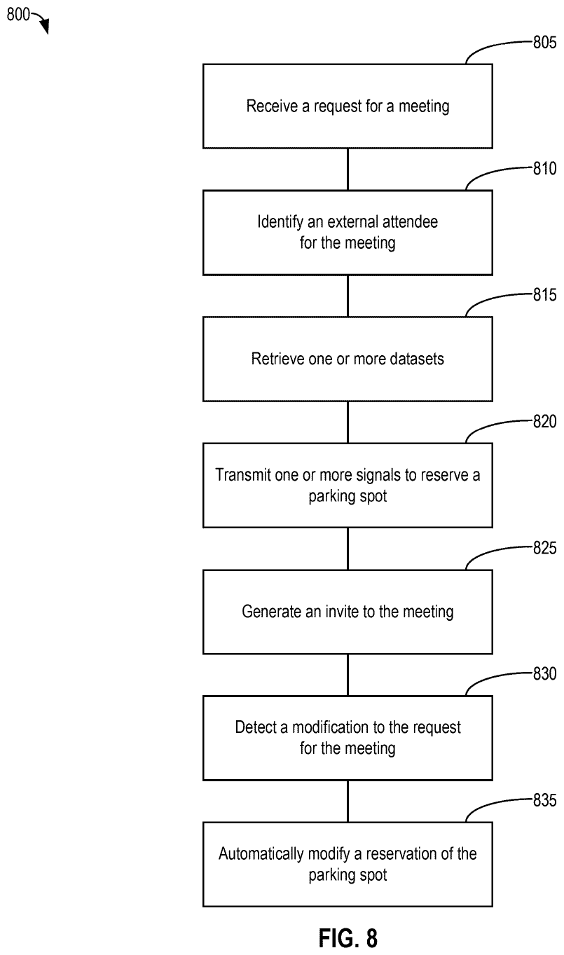

FIG. 8 is flow diagram of a method 800 to provide meeting integration for a Building Management System, according to some embodiments. In some embodiments, at least one of the various systems, devices, and/or components described herein may perform the method 800 and/or more steps thereof. For example, the meeting scheduling system 108 may perform at least one step of the method 800. In some embodiments, the method 800 and/or one or more steps thereof may be adjusted and/or otherwise changed such that one or more steps may be separated, combined, repeated, reproduced, duplicated, and/or replicated.

In some embodiments, at step 805, a request for a meeting may be received. For example, the visitor management system 102 may receive a request for a meeting from the client devices 110. The request for the meeting may be associated with the building 114. In some embodiments, the request may include information to identify an entity for the meeting. For example, the request may include information that identifies an external attendee (e.g., an entity). In some embodiments, the information may also indicate or identify a computing device (e.g., a client device 110) associated with the external attendee. The request may include one or more meeting parameters. For example, the request may include information, such as a date of the meeting, a duration of the meeting, one or more attendees for the meeting, a location of the meeting, and/or a meeting room.

In some embodiments, at step 810, an external attendee may be identified. For example, the visitor management system 102 may perform data scrapping to identify the external attendee from the information included in the request received in step 805. As another example, the request may include a tag that indicates the external attendee. In this example, the visitor management system 102 may identify the entity responsive to detection of the tag.

In some embodiments, at step 815, one or more datasets may be retrieved. For example, the visitor management system 102 may retrieve datasets that represent one or more parking spots and/or parking reservations with the parking management system 106. As another example, the visitor management system 102 may transmit one or more API calls, to the parking management system 106, to retrieve a list of parking reservations and/or a list of available parking spots.

In some embodiments, at step 820, one or more signals may be transmitted to reserve a parking spot. For example, the visitor management system 102 may transmit signals to the parking management system 106 to reserve a parking spot at the parking lot 116. As another example, the visitor management system 102 may reserve the parking spot by updating and/or modifying a database that includes parking reservations to include an indication that the parking spot as been reserved.

In some embodiments, at step 825, a visit to the meeting may be generated. For example, the visitor management system 102 may generate a visit for the external attendee identified in step 810. As another example, the visitor management system 102 may generate a visit by associating the parking spot, reserved in step 820, with one or more access control credentials. In some embodiments, the visitor management system 102 may generate the visit to provide various types of information to the external attendee. For example, the visit may include an indication of the parking spot reserved in step 820. As another example, the visit may indicate an arrival time for the external attendee.

In some embodiments, at step 830, a modification to the request for the meeting may be detected. For example, the visitor management system 102 may detect that a start time for the meeting has been adjusted. As another example, the visitor management system 102 may detect that a date of the meeting has been adjusted. In some embodiments, the visitor management system 102 may detect the modification by monitoring subsequent interactions with an application integrated with one or more systems. For example, the visitor management system 102 may monitor interactions with the building application 707 to detect a modification to a request for a meeting.

In some embodiments, at step 835, a reservation of a parking spot may be automatically adjusted. For example, the visitor management system 102 may adjust a time window for which a parking spot is reserved based on the modification to the request in step 830. In some embodiments, the visitor management system 102 may adjust the reservation of the parking spot reserved in step 820. In some embodiments, the visitor management system 102 may adjust the parking spot reservation by modifying one or more parameters of the reservation to reflect the modification. For example, the modification may be a change to a date of the meeting. In this example, the visitor management system 102 may adjust the reservation such that the parking spot is reserved for the date of the meeting.

In some embodiments, the visitor management system 102 may receive indications of one or more modifications to a meeting. For example, the visitor management system 102 may receive an indication of a modification to meetings parameters of a request. As another example, the visitor management system 102 may receive an indication of a change in the time of the meeting. In some embodiments, the visitor management system 102 may update the access control credential based on the modification. For example, the visitor management system 102 may adjust a duration for which the access control credential is active to reflect the modification to the meeting parameter. Stated otherwise, the visitor management system 102 may adjust the access control credential so that the access code control is active during the scheduled meeting.

In some embodiments, the visitor management system 102 may transmit one or more signals to provide the update to the access control credential. For example, the visitor management system 102 may transmit one or more signals to the access control devices 120 to adjust when the access control devices 120 may accept the access control credential. As another example, the visitor management system 102 may transmit signals to a computing device to inform the external attendee of the change (e.g., update) to the access control credential.

In some embodiments, the visitor management system 102 display one or more notifications of the update to the access control credential. For example, a display device may be located proximate to a given access control device 120. In this example, the visitor management system 102 may cause the display device to display a notification responsive to usage of the access control credential at the given access control device 120. As another example, the visitor management system 102 may cause a display device located proximate to an entry of the building 114 to display a notification of the update to the access control credential.

In some embodiments, the visitor management system 102 may prevent subsequent and/or duplicative generation of access control credentials. For example, the visitor management system 102 may detect that a second request for a second meeting includes an indication of an external attendee (e.g., entity) for which an access control credential was previously generated. In this example, the visitor management may prevent generation of a second control credential for the external attendee. In some embodiments, the visitor management system 102 may update and/or adjust the previously generated access control credential to reflect the second meeting. For example, the visitor management system 102 may increase an amount of time for which the previously generated access control credential is active (e.g., provides access).

In some embodiments, the visitor management system 102 may detect that one or more requests are duplicative. For example, the visitor management system 102 may detect that a first request for a meeting and a second request for a second meeting both include the same information. In this example, the visitor management system 102 may detect that the first request and the second request include the same meeting parameters. In some embodiments, the visitor management system 102 may have processed one of the requests prior to the other request. For example, the visitor management system 102 may have processed the first request before the second request. In this example, the visitor management system 102 may have already generated an access control credential based on the first request.

In some embodiments, the visitor management system 102 may provide one or more indications of the duplicative requests. For example, the visitor management system 102 may provide one or more indications by controlling display devices associated with hosts of the first request or the second request. In some embodiments, the visitor management system 102 may control the display devices to provide indications that the access control credential was generated. The visitor management system 102 may control the display devices to provide indications that the second request (e.g., a duplicative request) was cancelled and that an access control credential was generated based on the first request.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A system, comprising one or more memory devices storing instructions thereon that, when executed by one or more processors, cause the one or more processors to:
receive, via an application integrated within a meeting system of a building, a request for a meeting at the building, the request including (1) information to identify an external attendee for the meeting at the building and (2) meeting parameters;
identify, based at least on the information included in the request, the external attendee;
retrieve, from a parking system that controls access to a plurality of parking spots for the building, one or more datasets that represent one or more parking spots of the plurality of parking spots that correspond to the meeting parameters;
transmit one or more signals to the parking system to reserve a given parking spot of the one or more parking spots for the external attendee;
generate an invite to the meeting for the external attendee, wherein the invite includes an access control credential for the external attendee to provide access to the given parking spot;
detect a modification to the request for the meeting; and
automatically modify the reservation of the given parking spot for the external attendee by adjusting one or more parameters of the reservation of the given parking spot to reflect the modification to the request for the meeting.

2. The system of claim 1, wherein the modification to the request for the meeting includes at least one of a cancellation of the request for the meeting, a change to a time of the meeting, a change to a location of the meeting, or a change to a date of the meeting.

3. The system of claim 2, wherein adjusting the one or more parameters of the reservation of the given parking spot includes:
retrieving, from the parking systems, one or more second datasets that represent one or more second parking spots of the plurality of parking spots; and
transmitting one or more second signals to the parking system to reserve a second given parking spot of the one or more second parking spots.

4. The system of claim 2, wherein adjusting the one or more parameters of the reservation of the given parking spot includes:
transmitting one or more second signals to the parking system to change the reservation of the parking spot to reflect the change to the date of the meeting; and
transmitting one or more third signals to a computing device of the external attendee to indicate the change to the reservation of the parking spot.

5. The system of claim 1, wherein the application integrated within the meeting system includes at least one of:
an application stored on a user device that created the request;
a calendar software configured to receive one or more requests for meetings; or
a computing device located within the building.

6. The system of claim 1, wherein the request for the meeting is provided to the application by a computing device associated with a host of the meeting, and wherein the instructions cause the one or more processors to:
retrieve, from a database, a set of permissions associated with the host, the set of permissions to identify one or more second parking spots of the plurality of parking spots that the host has permission to reserve, the one or more second parking spots including the one or more parking spots.

7. The system of claim 1, wherein adjusting the one or more parameters of the reservation of the given parking spot includes:
automatically updating one or more parameters of the access control credential to reflect the modification to the request for the meeting;
wherein updating the one or more parameters of the access control credential includes at least one of:
adjusting a start time for which the access control credential provides access to the given parking spot; or
adjusting an end time for which the access control credential no longer provides access to the given parking spot.

8. The system of claim 1, wherein the request for the meeting includes an indication of a plurality of external attendees for the meeting, the plurality of external attendees including the external attendee, and wherein the instructions cause the one or more processors to:
monitor, responsive to generation of the invite, one or more interactions with the application integrated within a meeting system;
detect, responsive to monitoring the one or more interactions, the modification to the request for the meeting;
determine, responsive to detection of the modification to the request for the meeting, a number of external attendees of the plurality of external attendees that have parking reservations at the building; and
transmit, responsive to determination of the number of external attendees, one or more second signals the parking system to modify the parking reservations to reflect the modification to the request for the meeting.

9. A method, comprising:
receiving, by one or more processing circuits, via an application integrated within a meeting system of a building, a request for a meeting at the building, the request including (1) information to identify an external attendee for the meeting at the building and (2) meeting parameters;
identifying, by the one or more processing circuits, based at least on the information included in the request, the external attendee;
retrieving, by the one or more processing circuits, from a parking system that controls access to a plurality of parking spots for the building, one or more datasets that represent one or more parking spots of the plurality of parking spots that correspond to the meeting parameters;
transmitting, by the one or more processing circuits, one or more signals to the parking system to reserve a given parking spot of the one or more parking spots for the external attendee;
generating, by the one or more processing circuits, an invite to the meeting for the external attendee, wherein the invite includes an access control credential for the external attendee to provide access to the given parking spot;
detecting, by the one or more processing circuits, a modification to the request for the meeting; and
automatically modifying, by the one or more processing circuits, the reservation of the given parking spot for the external attendee by adjusting one or more parameters of the reservation of the given parking spot to reflect the modification to the request for the meeting.

10. The method of claim 9, wherein the modification to the request for the meeting includes at least one of a cancellation of the request for the meeting, a change to a time of the meeting, a change to a location of the meeting, or a change to a date of the meeting.

11. The method of claim 10, wherein adjusting the one or more parameters of the reservation of the given parking spot includes:
retrieving, by the one or more processing circuits, from the parking systems, one or more second datasets that represent one or more second parking spots of the plurality of parking spots; and
transmitting, by the one or more processing circuits, one or more second signals to the parking system to reserve a second given parking spot of the one or more second parking spots.

12. The method of claim 10, wherein adjusting the one or more parameters of the reservation of the given parking spot includes:
transmitting, by the one or more processing circuits, one or more second signals to the parking system to change the reservation of the parking spot to reflect the change to the date of the meeting; and
transmitting, by the one or more processing circuits, one or more third signals to a computing device of the external attendee to indicate the change to the reservation of the parking spot.

13. The method of claim 9, wherein the application integrated within the meeting system includes at least one of:
an application stored on a user device that created the request;
a calendar software configured to receive one or more requests for meetings; or
a computing device located within the building.

14. The method of claim 9, wherein the request for the meeting is provided to the application by a computing device associated with a host of the meeting, and comprising:
retrieving, by the one or more processing circuits, from a database, a set of permissions associated with the host, the set of permissions to identify one or more second parking spots of the plurality of parking spots that the host has permission to reserve, the one or more second parking spots including the one or more parking spots.

15. The method of claim 9, wherein adjusting the one or more parameters of the reservation of the given parking spot includes:
automatically updating, by the one or more processing circuits, one or more parameters of the access control credential to reflect the modification to the request for the meeting;
wherein updating the one or more parameters of the access control credential includes at least one of:
adjusting, by the one or more processing circuits, a start time for which the access control credential provides access to the given parking spot; or
adjusting, by the one or more processing circuits, an end time for which the access control credential no longer provides access to the given parking spot.

16. The method of claim 9, wherein the request for the meeting includes an indication of a plurality of external attendees for the meeting, the plurality of external attendees including the external attendee, and comprising:
monitoring, by the one or more processing circuits, responsive to generation of the invite, one or more interactions with the application integrated within a meeting system;
detecting, by the one or more processing circuits, responsive to monitoring the one or more interactions, the modification to the request for the meeting;
determining, by the one or more processing circuits, responsive to detection of the modification to the request for the meeting, a number of external attendees of the plurality of external attendees that have parking reservations at the building; and
transmitting, by the one or more processing circuits, responsive to determination of the number of external attendees, one or more second signals the parking system to modify the parking reservations to reflect the modification to the request for the meeting.

17. One or more non-transitory storage media storing instructions thereon that, when executed by one or more processors, cause the one or more processors to operations comprising:
receiving, via an application integrated within a meeting system of a building, a request for a meeting at the building, the request including (1) information to identify an external attendee for the meeting at the building and (2) meeting parameters;
identifying, based at least on the information included in the request, the external attendee;
retrieving, from a parking system that controls access to a plurality of parking spots for the building, one or more datasets that represent one or more parking spots of the plurality of parking spots that correspond to the meeting parameters;
transmitting one or more signals to the parking system to reserve a given parking spot of the one or more parking spots for the external attendee;
generating an invite to the meeting for the external attendee, wherein the invite includes an access control credential for the external attendee to provide access to the given parking spot;
detecting a modification to the request for the meeting; and
automatically modifying the reservation of the given parking spot for the external attendee by adjusting one or more parameters of the reservation of the given parking spot to reflect the modification to the request for the meeting.

18. The one or more non-transitory storage media of claim 17, wherein the modification to the request for the meeting includes at least one of a cancellation of the request for the meeting, a change to a time of the meeting, a change to a location of the meeting, or a change to a date of the meeting.

19. The one or more non-transitory storage media of claim 18, wherein adjusting the one or more parameters of the reservation of the given parking spot includes:
retrieving, from the parking systems, one or more second datasets that represent one or more second parking spots of the plurality of parking spots; and
transmitting one or more second signals to the parking system to reserve a second given parking spot of the one or more second parking spots.

20. The one or more non-transitory storage media of claim 18, wherein adjusting the one or more parameters of the reservation of the given parking spot includes:
transmitting one or more second signals to the parking system to change the reservation of the parking spot to reflect the change to the date of the meeting; and
transmitting one or more third signals to a computing device of the external attendee to indicate the change to the reservation of the parking spot.
